(19) United States
(12) Patent Application Publication
(10) Pub. No.: US 2013/0297828 A1
(43) Pub. Date: Nov. 7, 2013

(54) Flag to Synchronize a Service

(71) Applicants: Paul J. Broyles, III, Cypress, TX (US); Christoph Graham, Houston, TX (US)

(72) Inventors: Paul J. Broyles, III, Cypress, TX (US); Christoph Graham, Houston, TX (US)

(21) Appl. No.: 13/980,562

(22) PCT Filed: Jan. 18, 2011
(86) PCT No.: PCT/US11/21576

§ 371 Date: Jul. 18, 2013

(51) Int. Cl. H04L 29/08

(52) U.S. Cl. CPC H04L 67/1095
USPC 709/248

(57) ABSTRACT

In one embodiment a flag on a first client device on a network can indicate that a first service is to be synchronized with the second service on the network.

### BACKGROUND

A cloud allows a client device to retrieve information from a server. The devices may also synchronize information that is stored on the device with information that is stored on the server in the cloud. A user may for example have an email account on a server in the cloud and if a client device accesses the email account with an IMAP or POP3 email client on the client device the email client and the email account synchronize the email data.

### BRIEF DESCRIPTION OF THE DRAWINGS

Some embodiments of the invention are described with respect to the following figures:

FIG. 1 is a block diagram of a device to synchronize a service according to an example embodiment;

FIG. 2 is a block diagram of a system to synchronize a service according to an example embodiment;

FIG. 3 is a flow diagram of a method of synchronizing a service according to an example embodiment;

FIG. 4 is a flow diagram of a method of synchronizing a service according to an example embodiment; and

FIG. 5 is a server according to an example embodiment.

### DETAILED DESCRIPTION

In a cloud synchronization of the data is between a server in the cloud and a client synchronizing data with the server in the cloud. A first client cannot cause a second client to synchronize data with the first client or cause the second client to synchronize data with the server in the cloud.

The client may be for example a first client device. The first client device may be for example a personal computer (PC) such as a desktop, notebook, tablet, or may be for example a phone or another device. The first client device such as a tablet personal computer (PC) can be connected to a cloud and a second client device such as a printer can also be connected to the cloud and the first client device could not cause the second client device to print because the device do not synchronize information with each other through the cloud. Another example is a first client device such as a mobile phone that includes audio files such as MP3s and another device that would like to provide access to the audio files such as a car stereo. A user may not want to stream audio files from his mobile phone to the car stereo nor would they want use the storage space on the cloud for the audio files therefore synchronizing the data between devices allows the data to be on multiple devices without storing the data on the cloud. Providing a service that that can be synchronized through the cloud can allow client devices to synchronize data between devices. A service can be a program or routine or programs and routines that support other programs and routines. The synchronization of services may include selecting specific data or files that are to be synchronized between the services.

To synchronize data for services between devices a first client device may log on to a cloud profile. The cloud profile may provide a list of synchronizable services which may be as few as zero services. A user can select a service to synchronize and may also select specific data to synchronize. For example the user may allow devices to synchronize the audio files on the first client device which sets a flag that the audio files can be synchronized if the service is selected from the list. A second client device can receive a notification that the flag is set for the service on the first client device and if the second client device is set up to synchronize to that service the data can be synchronized between the first client device and the second client device.

In one embodiment, a device includes a flag that indicates that a first service is to be synchronized with the second service. The device can include a list to select a first service to synchronize with a second service through a network. A controller can respond to an inquiry about whether the flag is set for the first service or send out a notification that the flag is set for the first service.

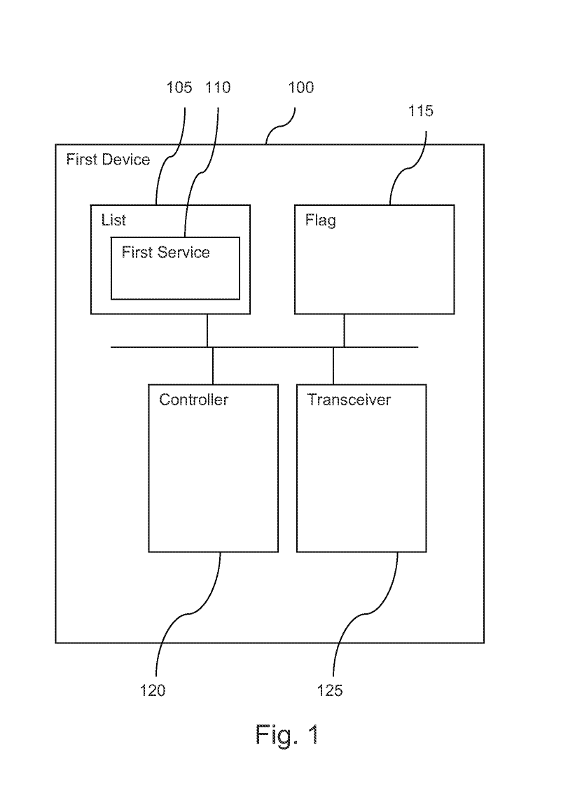

FIG. 1 is a block diagram of a device to synchronize a service according to an example embodiment. The first client device 100 can include a flag 115 that indicates that a first service 110 is to be synchronized with a second service. A flag can be a marker that is used by the first client device in processing or interpreting information such as a signal that indicated the existence or status of a particular condition. A flag can be code that identifies some condition or it can be one or more bits set by hardware or software to indicate an event.

For example if a service such as a printing service that is flagged may for example allow a user to flag specific files to be synchronized with a printer then the data from the service will be send from the first client device to a second client device for printing. Once the printer is done printing the data the service may be synchronized so that the data is not printed again the next time data is synchronized between the first client device and the second client device. In another example if the first client device included a music library that was flagged for synchronizing with a second client device the data in the music library would be synchronized to the second client device so that the data was on the first client device and the second client device.

The first client device 100 can include a list to select a first service to synchronize with a second service through a network. The list 105 may be generated by a server on the network that cumulates the services that are available. In one embodiment the first client device logs on to a profile. The profile may be for example a user profile that can provide unique data to different devices that are logged in using different profiles. A server on the network may include the user profile. A profile may have multiple devices logged on to the profile. Each device may have services that can be synchronized with other device on the profile or with other device on the network. The network may be a local area network (LAN) or wide area network (WAN) such as a cloud or the internet.

The list may include a service that can be synchronized with another service on the first client device, a service on other devices on the profile or services that are provided by another device on the network including devices that are not on the profile. A device may also be logged on to multiple profiles and the services may be synchronized between the profiles. For example if the first client device included a service that had a database of contacts and was synchronized to the first profile if the first client device logged in to a second profile the list may include a selection for synchronizing the contacts from the first profile to the second profile.

A controller 120 can respond to an inquiry about whether the flag is set for the first service or send out a notification that the flag is set for the first service. In one embodiment another device on the same profile may inquire to the first client device to provide a list of services that the other device can be synchronized to. The inquiry may occur in response to different events for example if the first client device logs on to the profile an inquiry may be made by another device or an inquiry may be made at a set interval. The other device may be provided with the services that have flags set.

The first client device may send out a notification of a flag being set for a service that can be synchronized. If a flag is set for a service that can be synchronized with the first client device a list on another device may be updated to include the service that can be synchronized with the first client device. The service may be selected on the other device to synchronize to the service on the first client device.

The first client device 100 can connect to the network through a transceiver 125. The transceiver 125 may be a network card that can provide connection to for example a wired or wireless network such as an Ethernet network, a wireless local area network (WLAN) including Wi-Fi, a wireless wide area network (WWAN) including cellular, a direct connection such as universal serial bus (USB) or another type of connection. The transceiver can send and receive data from servers and devices on the network if connected to the network.

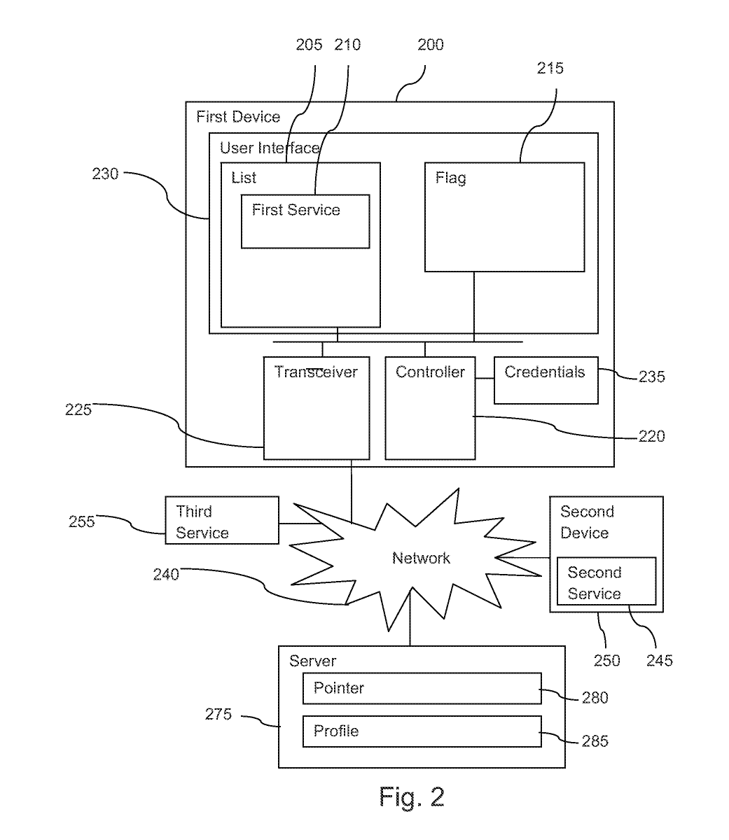

FIG. 2 is a block diagram of a system to synchronize a service according to an example embodiment. The first client device 200 can include a flag 215 that indicates that a first service 210 is to be synchronized with a second service. The first client device 200 can include a list to select a first service to synchronize with a second service through a network. The list 205 may be generated by a server on the network that cumulates the services that are available. In one embodiment the first client device logs on to a profile 285. The profile 285 may be for example a user profile that can provide unique data to different devices that are logged in using different profiles. A server 275 on the network may for example include the profile 285 and allow the first client device 200 to connect to the profile. A profile 285 may have multiple devices logged on to the profile 285. Each device may have a service that can be synchronized with another device on the profile or with another device on the network.

The list may include services that can be synchronized with another service on the first client device, services on another device on the profile or services that are provided by another devices on the network including devices that are not on the profile. A device may also be logged on to multiple profiles and the services may be synchronized between the profiles. For example if the first client device included a list of contacts and was synchronized to the first profile if the first client device logged in to a second profile the list may include a selection for synchronizing the contacts from the first profile to the second profile.

A controller 220 can respond to an inquiry about whether the flag 215 is set for the first service 210 or send out a notification that the flag 215 is set for the first service 210. In one embodiment a second client device 250 on the profile 285 may inquire to the first client device 200 to provide a flag 215 for a service that the third service 255 on the second client device 250 can be synchronized to. The inquiry may occur in response to different events for example if the first client device 200 logs on to the profile 285 an inquiry may be made by a second client device 250 or an inquiry may be made at a set interval by the second client device 250. The second client device may be provided with a service 210 that has a flag set.

The first client device 200 can send out a notification of a flag 215 being set for a first service 210 that can be synchronized. If a flag 215 is set for a first service 210 that can be synchronized with the first client device 200 a list on the second client device 250 may be updated to include the first service 210 that can be synchronized with the first client device 200. The first service 210 may be selected on the second client device 250 to synchronize to the first service 210 on the first client device 200.

The first client device 200 can connect to the network 240 through a transceiver 225. The transceiver can send and receive data from servers and devices on the network if connected to the network. The transceiver may be a network card that can provide connection to for example a wired or wireless network such as an Ethernet network, a wireless local area network (WLAN) including Wi-Fi, a wireless wide area network (WWAN) including cellular, a direct connection such as universal serial bus (USB) or another type of connection.

The server 275 can be connected to the network 240 to communicate with the controller 220 and request the flag 215 status for a first service 210. The server may retain a database of client devices connected to the network and flags that indicate a service that can be synchronized. The server 275 on the network 240 may communicate with the controller 220 and receive a notification of the flag status. For example if the flag status changes the controller 220 may broadcast the change in the flag status to the network which may be received by another device such as second client device 250 or by a server on the network such as server 275.

In one embodiment a flag 215 may cause a server 275 to log on to the second service 245 to synchronize data between the first service 210 and the second service 245 if the flag is set to indicate to synchronize data. If the server is aware of a second service 245 that is available on the network 240 the server 275 may connect the first service 210 to the second service 245 to synchronize data between the first service 210 and the second service 245. For example if the first service 210 is for printing the server 275 may be aware of a printer with a second service 245 and the second service 245 can be synchronized with the first service 210 without the first service 210 synchronizing with the server 275 and then the second service 245 synchronizing with the server 275.

An action may initiated by the second service 245 if the second service is synchronized with the first service 210. The action may be for example to provide a notification. The notification may be to indicate successful synchronization or errors in the synchronization of data. If the first service 210 is a print service then the successful notification may he for example that a document has printed.

A third service 255 can be synchronized with the first service 210 if the flag is set to indicate synchronization. The data from the first service 210 may be synchronized with the data on the third service 255 through the network 240.

On a pointer 280 may be on the network to prevent duplication of data during a synchronization of data between a first service and a second service. The pointer 280 may be for example on a server 275. The pointer 280 may for example identify the origin of data so that the data is not sent back to the originator of the data. The pointer 280 may be stored with the data on a first client device 200 or the second client device 250 in addition to the server 275 or in the alternative to the server 275.

The first client device may include a user interface 230 to set the flag 215 to indicate at least one of automatic synchronization or on demand synchronization. The user interface 230 may allow a flag to be set that provides that data is synchronized between services automatically or that there is a demand notification if data is awaiting synchronization. The user interface 230 may also provide the list 205 to the user for selecting the services to synchronize.

If the flag 215 indicates that the first service 210 and the second service 245 are to synchronize data the first client device 200 may provide credentials 235 to connect to the second service 245. The credentials may be may be an identifier such as a user name and/or proof of identification such as a password, smartcard or certificate.

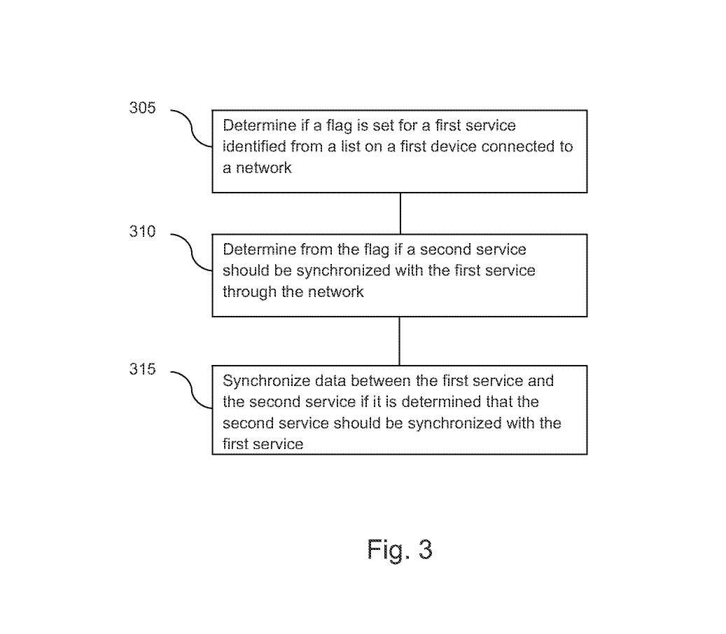

FIG. 3 is a flow diagram of a method of synchronizing a service according to an example embodiment. The method can include determining if a flag is set for a first service identified from a list on a first client device connected to a network at 305. The determination of if the flag is set for the first service may be done by a server on a network or another device on the network. The server or the other device on the network may inquire about the flag or may receive a notification of the flag from the first client device.

If the flag is set it may be determined from the flag if a second service should be synchronized with the first service through the network at 310. For example a second client device may include a second service that could use the data from the first service and determine that the two services should be synchronized. In another example the server on the network may determine that a service available on the network should be synchronized with the first service. If it is determined that the first service and the second service are to be synchronized then the data can be synchronized between the first service and the second service at 315.

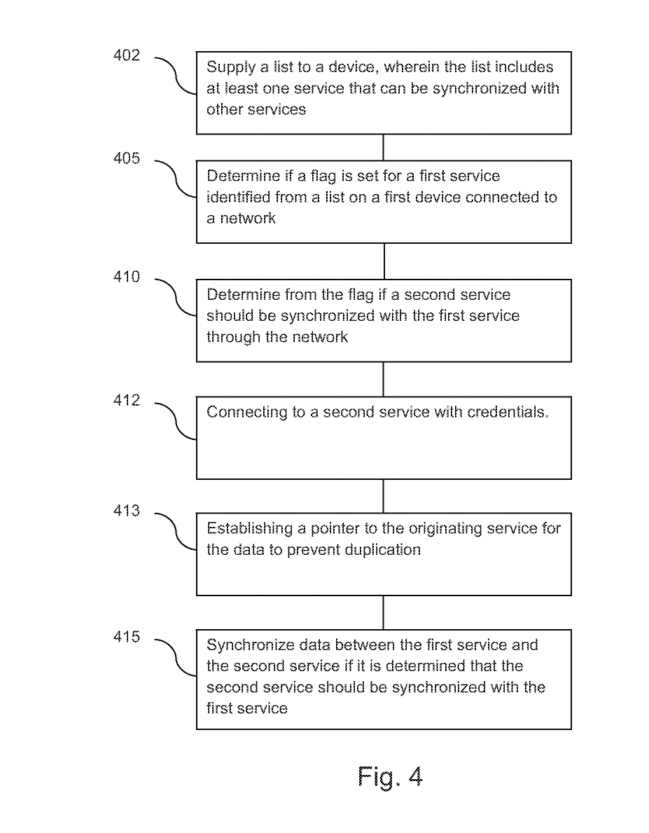

FIG. 4 is a flow diagram of a method of synchronizing a service according to an example embodiment. The method can include determining if a flag is set for a first service identified from a list on a first client device connected to a network at 405. The determination of if the flag is set for the first service may be done by a server on a network or another device on the network. The server or the other device on the network may inquire about the flag or may receive a notification of the flag from the first client device.

If the flag is set it may be determined from the flag if a second service should be synchronized with the first service through the network at 410. For example a second client device may include a second service that could use the data from the first service and determine that the two services should be synchronized. In another example the server on the network may determine that a second service available on the network should be synchronized with the first service. The second service may be connected to by credentials supplied by the first service at 412. A request for the credentials may cause the credentials to be supplied by the first service.

In one embodiment, a list may be supplied by the first client device, a second client device or a server on the network at 402. The list can include at least one service that can be synchronized with other services on the network. The list may be generated by a server on the network. The list may be a compilation of flags from multiple devices on the network providing services. To prevent duplication of the data between services there can be a pointer established to the originating service for the data at 413.

If it is determined that the first service and the second service are to be synchronized then the data can be synchronized between the first service and the second service at 415.

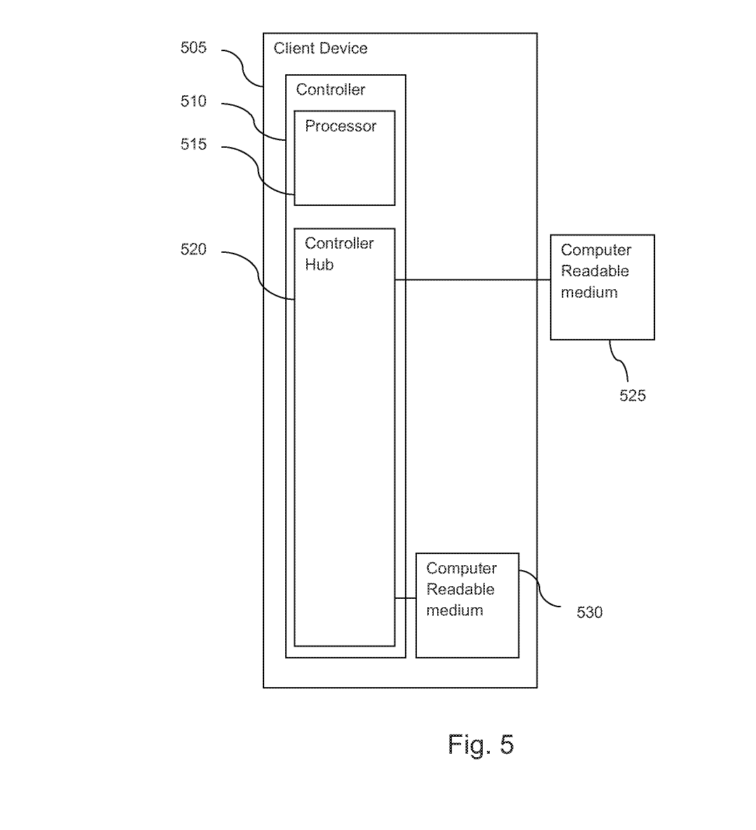

FIG. 5 is a client device according to an example embodiment. The client device 505 may include an internal computer readable medium such as 530 or an external computer readable medium such as 525 can be connected to a processor 510 through a controller hub 520. The controller hub 520 may be for example a chip set. The controller hub 520 can connect to peripherals for example. The processor 510 and the controller hub 520 may be in a single die or may be in separate dies. The processor 510 and the controller hub 520 may be in a single package or separate packages. The processor and controller hub together is a controller 510. The computer readable medium can include code that if executed by a processor 510 causes the client device 505 to receive an indication that a flag for a first service on a first client device connected to the network is set. The processor 510 can determine if the flag indicates that data from the first service should be synchronized with a second service. The processor can connect to the second service to synchronize the data from the first service to the second service.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A first client device comprising:
a flag that indicates that a first service is to be synchronized with the second service;
a list to select a first service to synchronize with a second service through a network; and
a controller to do at least one of respond to an inquiry about whether the flag is set for the first service and send out a notification that the flag is set for the first service.

2. The device of claim 1, further comprising a profile on the network wherein the first client device connects to the profile.

3. The device of claim 2, wherein the profile provides the list to the first client device.

4. The device of claim 1, wherein the flag causes a server to log on to the second service to synchronize data between the first service and the second service if the flag is set to indicate to synchronize data.

5. The device of claim 1, further comprising an action that is initiated by the second service if the second service is synchronized with the first service.

6. The device of claim 1, further comprising a third service that can be synchronized with the first service if the flag is set to indicate synchronization.

7. The device of claim 1, further comprising a pointer to the first service to synchronize data provided by the first service without duplication.

8. The device of claim 1, further comprising a user interface to set the flag to indicate at least one of automatic synchronization or on demand synchronization.

9. The device of claim 1, further comprising credentials that are supplied by the first client device to connect to the second service if the flag is indicated.

10. A method of service synchronization on a network comprising:
determining if a flag is set for a first service identified from a list on a first client device connected to a network;
determining from the flag if a second service should be synchronized with the first service through the network; and
synchronizing data between the first service and the second service if it is determined that the second service should be synchronized with the first service.

11. The method of claim 10, wherein determining if a second service should be synchronized with the first service is done with credentials supplied by the first service.

12. The method of claim 11, further comprising requesting the credentials from the first client device.

13. The method of claim 10, further comprising establishing a pointer to an originating service for the data to prevent duplication.

14. A computer readable medium comprising code that if executed causes a client device on a network to:
receive an indication that a flag for a first service on a first client device connected to the server is set;
determine if the flag indicates that data from the first service should be synchronized with a second service; and
connecting to the second service to synchronize the data from the first service to the second service.

15. The computer readable medium of claim 14 further comprising code that if executed causes a client device to:
connect to the second service with credentials supplied by the first service.
